(19) United States
(12) Patent Application Publication
(10) Pub. No.: US 2020/0175455 A1
(43) Pub. Date: Jun. 4, 2020

(54) CLASSIFICATION OF SKILLS

(71) Applicant: Microsoft Technology Licensing, LLC, Redmond, WA (US)

(72) Inventors: Jeffrey Douglas Gee, San Francisco, CA (US); Rohan Ramanath, Saratoga, CA (US); Deepak Kumar, Mountain View, CA (US); Vasudeva Nagaraja, San Jose, CA (US)

(21) Appl. No.: 16/206,729

(22) Filed: Nov. 30, 2018

(51) Int. Cl. G06Q 10/06; G06Q 10/10; G06F 17/18

(52) U.S. Cl. CPC G06Q 10/063112; G06F 17/18; G06Q 10/1053

(57) ABSTRACT

A skills classification system is configured to calculate, for a skill from the skills database, industry-specific probabilities for the industries associated with the skill. An industry-specific probability for an industry with respect to a skill is the probability of that skill being a required skill for a job associated with that industry. The skills classification system also calculates an industry-agnostic probability with respect to that same skill, which is the probability of the skill being a required skills for any job regardless of the industry. Based on the distance between the set of industry-specific probabilities for the industries associated with the skill and the industry-agnostic probability, the skills classification system calculates a score for the skill. This score is used to determine whether the skill should be tagged with a soft skill identifier or a hard skill identifier.

### TECHNICAL FIELD

This application relates to the technical fields of software and/or hardware technology and, in one example embodiment, to system and method to classify a skill as a soft or a hard skill in an on-line connection network system.

### BACKGROUND

An on-line connection network is a platform for connecting people in virtual space. An on-line connection network may be a web-based platform, such as, e.g., a connection networking web site, and may be accessed by a user via a web browser or via a mobile application provided on a mobile phone, a tablet, etc. An on-line connection network may be a business-focused connection network that is designed specifically for the business community, where registered members establish and document networks of people they know and trust professionally. Each registered member may be represented by a member profile. A member profile may be represented by one or more web pages, or a structured representation of the member's information in XML (Extensible Markup Language), JSON (Java Script Object Notation) or similar format. A member's profile web page of a connection networking web site may emphasize employment history and professional skills of the associated member. An on-line connection network is also configured to facilitate job-related searches and aid members by recommending jobs that match their professional skills and experience. An on-line connection network may include one or more components for matching member profiles with those job postings that may be of interest to the associated member.

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a diagrammatic representation of a network environment within which an example method and system to classify a skill as a soft or a hard skill in an on-line connection network may be implemented;

FIG. 2 is a block diagram of a system to classify a skill as a soft or a hard skill in an on-line connection network, in accordance with one example embodiment;

FIG. 3 is a flowchart illustrating a method to classify a skill as a soft or a hard skill in an on-line connection network, in accordance with an example embodiment; and

FIG. 4 is a diagrammatic representation of an example machine in the form of a computer system within which a set of instructions, for causing the machine to perform any one or more of the methodologies discussed herein, may be executed.

### DETAILED DESCRIPTION

A method and system to classify a skill as a soft or a hard skill in an on-line connection network in an on-line connection network system are described. In the following description, for purposes of explanation, numerous specific details are set forth in order to provide a thorough understanding of an embodiment of the present invention. It will be evident, however, to one skilled in the art that the present invention may be practiced without these specific details.

As used herein, the term “or” may be construed in either an inclusive or exclusive sense. Similarly, the term “exemplary” is merely to mean an example of something or an exemplar and not necessarily a preferred or ideal means of accomplishing a goal. Additionally, although various exemplary embodiments discussed below may utilize Java-based servers and related environments, the embodiments are given merely for clarity in disclosure. Thus, any type of server environment, including various system architectures, may employ various embodiments of the application-centric resources system and method described herein and is considered as being within a scope of the present invention.

For the purposes of this description the phrases “an on-line connection networking application” and “an on-line connection network system” may be referred to as and used interchangeably with the phrase “an on-line connection network” or merely “a connection network.” It will also be noted that an on-line connection network may be any type of an on-line connection network, such as, a professional network, an interest-based network, or any on-line networking system that permits users to join as registered members. Each member of an on-line connection network is represented by a member profile (also referred to as a profile of a member or simply a profile). A member profile may be associated with connection links that indicate the member's connection to other members of the connection network. The profile information of a connection network member may include various information such as, e.g., the name of a member, current and previous geographic location of a member, current and previous employment information of a member, information related to education of a member, information about professional accomplishments of a member, publications, patents, as well as information about the member's professional skills. A skill, for the purposes of this description is an item of information that represents a skill of a member in an on-line connection network system and that is stored in a skills database maintained by the on-line connection network system. Each skill-related entry in the skills database includes a phrase (e.g., “programming” or “patent prosecution”) that can correspond to a string included in one or more designated profile sections in a member profile maintained by the on-line connection network system, such as, e.g., in the skills and endorsements section of a profile. Skill-related entries in the skills database can also correspond to strings included in job postings maintained by the on-line connection network system. A job posting, also referred to as merely “job” for the purposes of this description, is an electronically stored entity maintained by the on-line connection network system that includes information that an employer may post with respect to a job opening. In addition to the required skills that correspond to entries in the skills database, the information in a job posting may include, e.g., industry, company, job position, geographic location of the job, etc. The on-line connection network system may include a recommendation system configured to select one or more job postings for presentation to a member based on criteria that indicates that a particular job posting is likely to be a match with respect to the member's profile. The criteria that indicates that a particular job posting is likely to be a match to the member's profile includes respective skills reflected in the member's profile and required skills reflected in the job posting.

Returning to the notion of skills, some skills that may be required for a job are in large part knowledge-centric. These academic or domain-specific skills (e.g., C++ or organic chemistry) can be acquired in a classroom or from a text book. Other skills are those that are acquired mainly through experience or social development. Examples of such skills are leadership and problem solving. For the purposes of this description, academic or domain-specific skills are referred to as hard skills, while those skills that are acquired mainly through experience or natural talent are referred to as soft skills. Soft skills are often listed in job postings alongside the hard skills without explicitly identifying them as such; consequently, a recommendation system treats these different types of skills in a similar manner when matching a member profile with jobs. In situations where a member is unable to explicitly distinguish skill-types in their member profile, this lack of distinction may lead to a less accurate matching of jobs for the member and may result in less than optimal user experience. While one can intuitively discern whether a given skill is a soft skill or a hard skill, existing systems were unable to automatically make such determination. Described herein is the methodology for determining whether a skill from a skills database maintained in an on-line connection network system is a hard skill or a soft skill, which is an improvement in computer-related technology and, specifically, in on-line connection network systems that maintains electronic profiles representing members and job postings.

The technical problem of automatically determining whether a skill from a skills database maintained in an on-line connection network system is a hard skill or a soft skill is addressed by providing a skills classification system configured to make that determination. The skills classification system operates on the premise that a skill that is in high demand in some industries but the demand for the same skill is low or non-existent for other industries is a skill that requires specialized study and training (a hard skill). On the other hand, a skill that is demanded equally across all industries is a skill that is achieved with the passage of time and a gained experience (a soft skill). To put it differently, while the distribution of a hard skill across the jobs in a given industry is a function of that given industry, the distribution of a soft skill across jobs is not as dependent on the type of industry.

In operation, the vast number of job postings maintained in the on-line connection network system, together with the standardized data (such as standardized skills and standardized industries) can be used to organize skill entities and industry entities in a way suitable for identifying a skill as a hard or a soft skill. While a job posting may have an explicit indication of an associated industry, this may not be the case for every job posting. The required skills listed in a job posting can be used to determine, based on the standardized industries and the standardized skills, an industry associated with a given job posting. Once every job posting is associated with an industry, each industry can be associated with a set of jobs from that particular industry. Based on its set of jobs and the respective required skills included in those jobs, each industry can be associated with a set of skills (the skills that are in demand in that industry). Conversely, the respective required skills included in jobs and the industries associated with respective jobs can be used to derive a set of industries associated with each skill (e.g., by selecting for a given skill, those industries that are associated with jobs listing the given skill in its required skills).

In one example embodiment, for a skill from the skills database, the skills classification system calculates industry-specific probabilities (for the industries associated with the skill). An industry-specific probability for an industry with respect to a skill is the probability of the industry being associated with a randomly selected job requiring that skill. This can be notated as P(i|s). The skills classification system also calculates an industry-agnostic probability with respect to that same skill, which is the probability of the skill being a required skill for any job regardless of the industry. This can be notated as P(industry|all jobs). Based on the distance between the set of industry-specific probabilities for the industries associated with the skill and the industry-agnostic probability, the skills classification system calculates a score for the skill. This score is then used to determine whether the skill should be tagged with a soft skill identifier or a hard skill identifier. In one embodiment, when respective scores have been calculated each skill in the skills database, a certain number of skills having the lowest scores can be tagged as soft skills and a certain number of skills having the highest scores can be tagged as hard skills. These scores for skills can be periodically recalculated and the skills retagged if needed.

In some embodiments, a score for a subject skill is calculated as the Kullback-Leibler divergence, as shown in Equation (1) below.

$$D ( P \text{\textbar \textbar} {Q}_{I} ) = {\sum }_{i ∈ I} P * log \frac{{Q}_{I} ( i )}{P} , \qquad Equation ( 1 )$$

where:

I is a set of industries associated with the subject skill,

P is an industry-agnostic probability of the subject skill being in required skills for a job from the plurality of job postings,

Q₁ a set of respective industry-specific probabilities, each value Q₁(i) in the set is probability of the subject skill being in required skills for a job from job postings associated with industry i from the set of industries I.

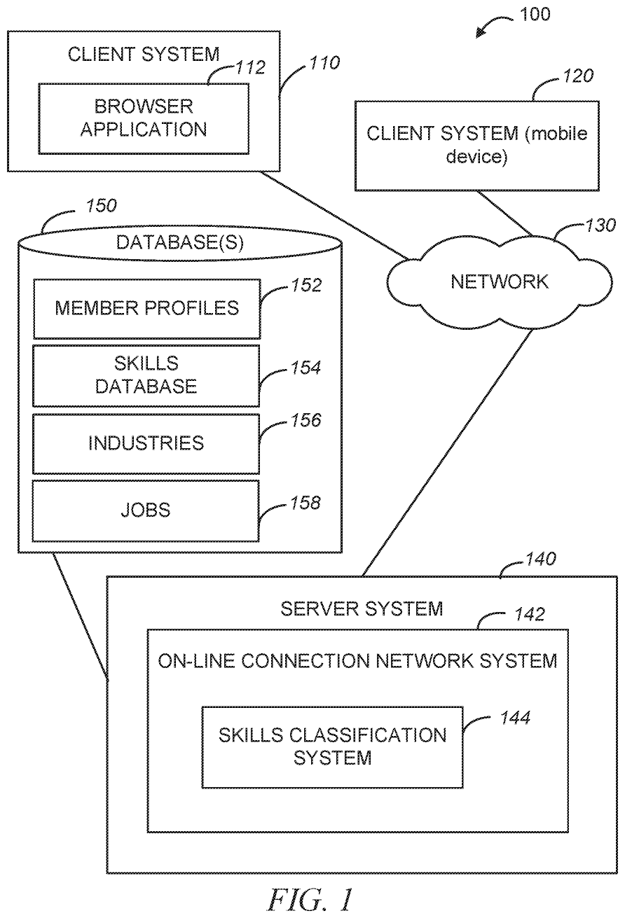

As mentioned above, respective identifications of skills as hard or soft may be surfaces to members of the on-line connection network system as a member is presented with job search results or job recommendations. Also, in determining whether a job posting is a match with respect to a member profile, a recommendation system provided with the on-line connection network system may assign greater weight to hard skills in a job and lower weight to soft skills. In some embodiments, soft skills may be omitted altogether in matching jobs with member profiles. An example skills classification system may be implemented in the context of a network environment 100 illustrated in FIG. 1.

As shown in FIG. 1, the network environment 100 may include client systems 110 and 120 and a server system 140. The client system 120 may be a mobile device, such as, e.g., a mobile phone or a tablet. The server system 140, in one example embodiment, may host an on-line connection network system 142. As explained above, each member of an on-line connection network is represented by a member profile that contains personal and professional information about the member and that may be associated with connection links that indicate the member's connection to other member profiles in the on-line connection network. Member profiles and related information may be stored in a database 150 as member profiles 152. The database 150 also includes a skills database 154 and also stores industries and industries 156 and jobs as jobs 158.

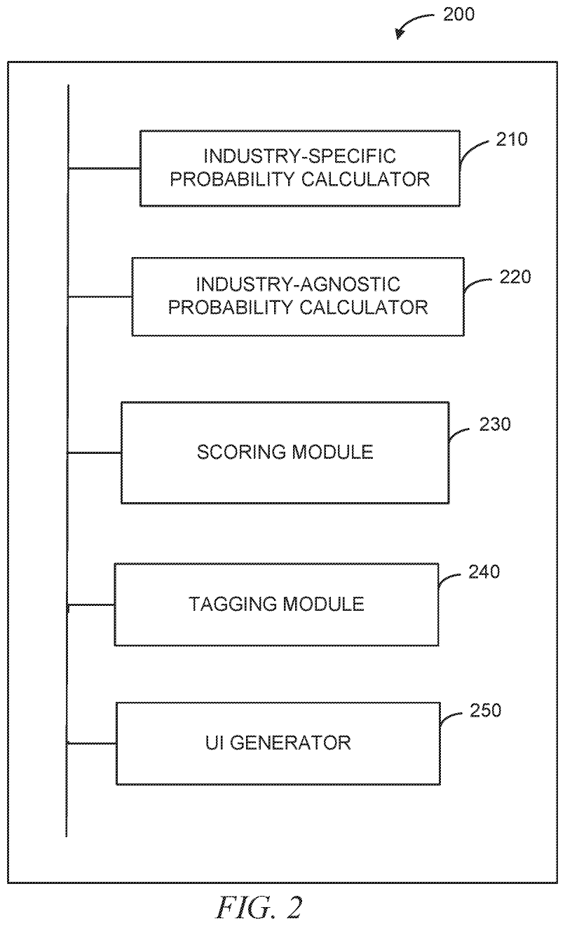

The client systems 110 and 120 may be capable of accessing the server system 140 via a communications network 130, utilizing, e.g., a browser application 112 executing on the client system 110, or a mobile application executing on the client system 120. The communications network 130 may be a public network (e.g., the Internet, a mobile communication network, or any other network capable of communicating digital data). As shown in FIG. 1, the server system 140 also hosts a skills classification system 144. The skills classification system 144 is configured to classify a skill as a hard skill or not a hard skill (a soft skill) in an on-line connection network, applying methodologies discussed herein. An example skills classification system 144 is illustrated in FIG. 2.

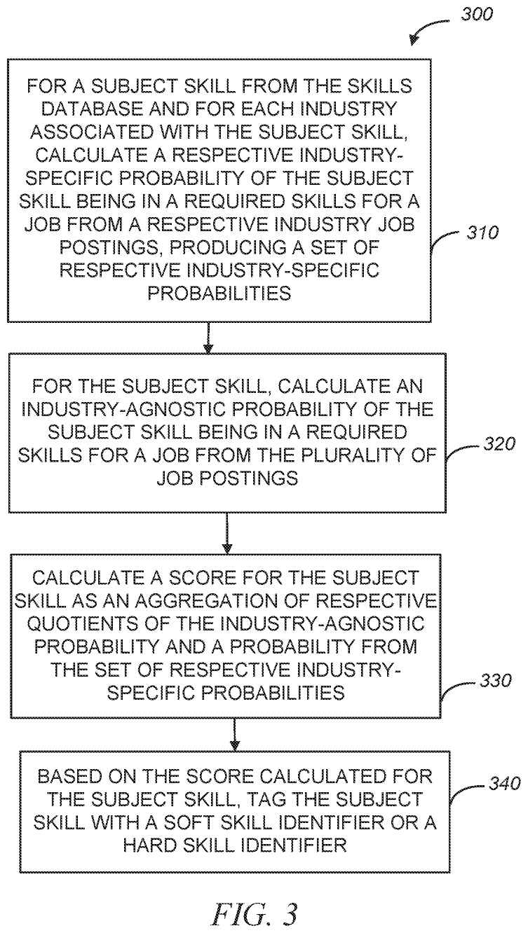

FIG. 2 is a block diagram of a system 200 to classify a skill as a soft or a hard skill in an on-line connection network. As shown in FIG. 2, the system 200 includes an industry-specific probability calculator 210, an industry-agnostic probability calculator 220, a scoring module 230, a tagging module 240, and a UI generator 250. As explained above, the on-line connection network system maintains a skills database storing skills, where each skill in the skills database is associated with a respective set of industries. The on-line connection network system also maintains job postings, where each job posting is associated with one or more industries and also has a set of required skills from the skills database. Each industry maintained by the on-line connection network system is, in turn, associated with its set of industry job postings. The industry-specific probability calculator 210 is configured to calculate industry-specific probabilities of a skill (referred to as a subject skill, since it is the subject of the determination whether it is a hard or a soft skill) with respect to industries associated with that skill, thus producing a set of respective industry-specific probabilities for the subject skill. The industry-agnostic probability calculator 220 is configured to calculate an industry-agnostic probability of the subject skill. The scoring module 230 is configured to calculate a score for the subject skill as an aggregation of respective quotients of the industry-agnostic probability and a probability from the set of respective industry-specific probabilities. The tagging module 240 is configured to tag the subject skill with a soft skill identifier or a hard skill identifier based on the score calculated for the subject skill. The UI generator 250 is configured to generate a career advice user interface (UI), the generating comprising including in the career advice UI a reference to the subject skill and an identification of the subject skill as a soft skill or a hard skill, which can be in response to a member represented by a member profile in the on-line connection network system selecting one or more job postings that have the subject skill as a required skill. Some operations performed by the system 200 may be described with reference to FIG. 3.

FIG. 3 is a flowchart of a method 300 to classify a skill as a soft or a hard skill in an on-line connection network 142 of FIG. 1. The method 300 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the server system 140 of FIG. 1 and, specifically, at the system 200 shown in FIG. 2.

As shown in FIG. 3, the method 300 commences at operation 310, when the industry-specific probability calculator 210 calculates industry-specific probabilities of a subject skill. The industry-agnostic probability calculator 220 calculates an industry-agnostic probability of the subject skill at operation 320. The scoring module 230 calculates a score for the subject skill as an aggregation of respective quotients of the industry-agnostic probability and a probability from the set of respective industry-specific probabilities at operation 240. The tagging module 240 tags the subject skill with a soft skill identifier or a hard skill identifier based on the score calculated for the subject skill, at operation 250.

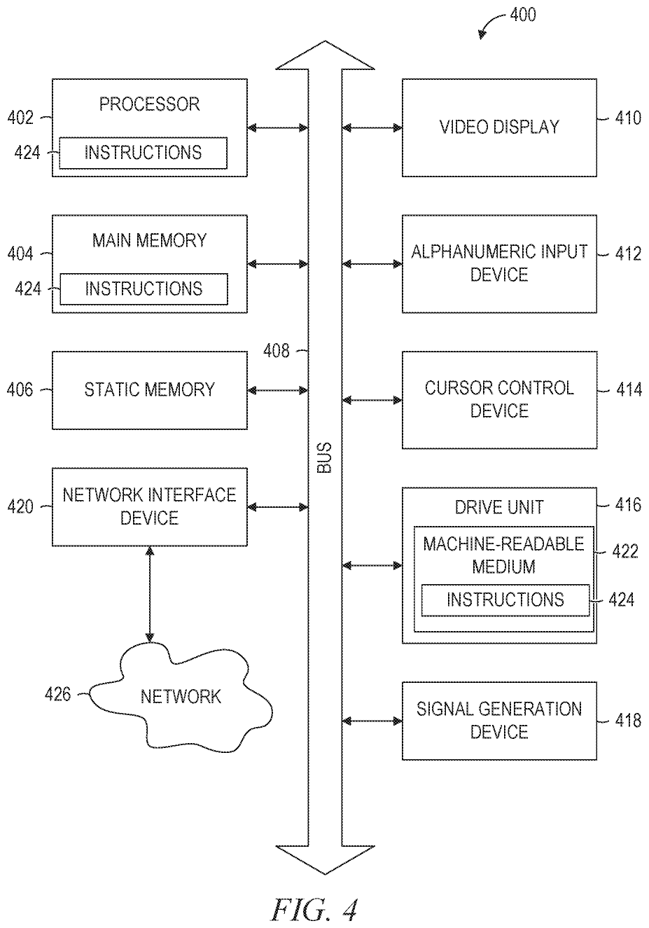

FIG. 4 is a diagrammatic representation of a machine in the example form of a computer system 400 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 includes a processor 402 (e.g., a central processing unit (CPU), a graphics processing unit (GPU) or both), a main memory 404 and a static memory 406, which communicate with each other via a bus 404. The computer system 400 may further include a video display unit 410 (e.g., a liquid crystal display (LCD) or a cathode ray tube (CRT)). The computer system 400 also includes an alpha-numeric input device 412 (e.g., a keyboard), a user interface (UI) navigation device 414 (e.g., a cursor control device), a disk drive unit 416, a signal generation device 418 (e.g., a speaker) and a network interface device 420.

The disk drive unit 416 includes a machine-readable medium 422 on which is stored one or more sets of instructions and data structures (e.g., software 424) embodying or utilized by any one or more of the methodologies or functions described herein. The software 424 may also reside, completely or at least partially, within the main memory 404 and/or within the processor 402 during execution thereof by the computer system 400, with the main memory 404 and the processor 402 also constituting machine-readable media.

The software 424 may further be transmitted or received over a network 426 via the network interface device 420 utilizing any one of a number of well-known transfer protocols (e.g., Hyper Text Transfer Protocol (HTTP)).

While the machine-readable medium 422 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-state memories, optical and magnetic media. Such media may also include, without limitation, hard disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware. Such embodiments of the inventive subject matter may be referred to herein, individually or collectively, by the term “invention” merely for convenience and without intending to voluntarily limit the scope of this application to any single invention or inventive concept if more than one is, in fact, disclosed.

### MODULES, COMPONENTS AND LOGIC

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

Thus, a method and system to classify a skill as a soft or a hard skill in an on-line connection network has been described. Although embodiments have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense.

1. A computer implemented method comprising:
in an on-line connection system, maintaining a skills database storing skills, each skill in the skills database associated with a respective set of industries;
in the on-line connection system, maintaining a plurality of job postings, each job posting from the plurality of job postings associated with one or more industries and having a set of required skills from the skills database, each industry from the one or more associated industries associated with its set of industry job postings;
for a subject skill from the skills database, producing a set of respective industry-specific probabilities by calculating, for each industry associated with the subject skill, a respective industry-specific probability of the subject skill being in required skills for a job from a respective industry job posting;
for the subject skill, calculating an industry-agnostic probability of the subject skill being in required skills for a job from the plurality of job postings;
using at least one processor, calculating a score for the subject skill using the industry-agnostic probability and a probability from the set of respective industry-specific probabilities; and
based on the score calculated for the subject skill, tagging the subject skill with a soft skill identifier or a hard skill identifier.

2. The method of claim 1, comprising determining respective industries for each job in the plurality of jobs based on respective required skills listed in each of the plurality of jobs.

3. The method of claim 1, comprising, based on respective industries associated with each job in the plurality of jobs, determining, for each industry, a respective set of industry jobs.

4. The method of claim 1, comprising, based on sets of requires skills in respective sets of industry jobs, associating each skill in the skills database with a respective set of industries.

5. The method of claim 1, comprising tagging the subject skill with the soft skill identifier based on the score being below a predetermined threshold.

6. The method of claim 1, comprising tagging the subject skill with the hard skill identifier based on the score being above a predetermined threshold.

7. The method of claim 1, comprising, for each skill in the skills database calculating a score and tagging the skill with the soft skill identifier or the hard skill identifier based on the score.

8. The method of claim 7, comprising generating a recommendation with respect to a job posting to a member represented by a member profile in the on-line connection network system based only on those skills from required skills in the job postings that are tagged with the hard skill identifier.

9. The method of claim 1, wherein the calculating a score for the subject skill comprises aggregating respective quotients of the industry-agnostic probability and a probability from the set of respective industry-specific probabilities.

10. The method of claim 1, comprising:
accessing one or more job postings selected by a member represented by a member profile in the on-line connection network system;
identifying those skills from the skills database that are included as required skills in the one or more job postings, the skills from the skills database that are included as required skills in the one or more job postings including the subject skill; and
generating a career advice user interface (UI), the generating comprising including in the career advice UI a reference to the subject skill and an identification of the subject skill as a soft skill or a hard skill.

11. A system comprising:
one or more processors; and
a non-transitory computer readable storage medium comprising instructions that when executed by the one or processors cause the one or more processors to perform operations comprising:
in an on-line connection system, maintaining a skills database storing skills, each skill in the skills database associated with a respective set of industries;
in the on-line connection system, maintaining a plurality of job postings, each job posting from the plurality of job postings associated with one or more industries and having a set of required skills from the skills database, each industry from the one or more associated industries associated with its set of industry job postings;
for a subject skill from the skills database, producing a set of respective industry-specific probabilities by calculating, for each industry associated with the subject skill, a respective industry-specific probability of the subject skill being in required skills for a job from a respective industry job posting;
for the subject skill, calculating an industry-agnostic probability of the subject skill being in required skills for a job from the plurality of job postings;
calculating a score for the subject skill using the industry-agnostic probability and a probability from the set of respective industry-specific probabilities; and
based on the score calculated for the subject skill, tagging the subject skill with a soft skill identifier or a hard skill identifier.

12. The system of claim 11, wherein the one or more processors to perform operations comprising determining respective industries for each job in the plurality of jobs based on respective required skills listed in each of the plurality of jobs.

13. The system of claim 11, wherein the one or more processors to perform operations comprising, based on respective industries associated with each job in the plurality of jobs, determining, for each industry, a respective set of industry jobs.

14. The system of claim 11, wherein the one or more processors to perform operations comprising, based on sets of requires skills in respective sets of industry jobs, associating each skill in the skills database with a respective set of industries.

15. The system of claim 11, wherein the one or more processors to perform operations comprising tagging the subject skill with the soft skill identifier based on the score being below a predetermined threshold.

16. The system of claim 11, wherein the one or more processors to perform operations comprising tagging the subject skill with the hard skill identifier based on the score being above a predetermined threshold.

17. The system of claim 11, wherein the one or more processors to perform operations comprising, for each skill in the skills database calculating a score and tagging the skill with the soft skill identifier or the hard skill identifier based on the score.

18. The system of claim 17, wherein the one or more processors to perform operations comprising generating a recommendation with respect to a job posting to a member represented by a member profile in the on-line connection network system based only on those skills from required skills in the job postings that are tagged with the hard skill identifier.

19. The system of claim 11, wherein the calculating a score for the subject skill comprises aggregating respective quotients of the industry-agnostic probability and a probability from the set of respective industry-specific probabilities.

20. A machine-readable non-transitory storage medium having instruction data executable by a machine to cause the machine to perform operations comprising:
in an on-line connection system, maintaining a skills database storing skills, in an on-line connection system, maintaining a skills database storing skills, each skill in the skills database associated with a respective set of industries;
in the on-line connection system, maintaining a plurality of job postings, each job posting from the plurality of job postings associated with one or more industries and having a set of required skills from the skills database, each industry from the one or more associated industries associated with its set of industry job postings;
for a subject skill from the skills database, producing a set of respective industry-specific probabilities by calculating, for each industry associated with the subject skill, a respective industry-specific probability of the subject skill being in required skills for a job from a respective industry job posting;
for the subject skill, calculating an industry-agnostic probability of the subject skill being in required skills for a job from the plurality of job postings;
calculating a score for the subject skill using the industry-agnostic probability and a probability from the set of respective industry-specific probabilities; and
based on the score calculated for the subject skill, tagging the subject skill with a soft skill identifier or a hard skill identifier.
